(19) United States
(12) Patent Application Publication
(10) Pub. No.: US 2022/0019209 A1
(43) Pub. Date: Jan. 20, 2022

(54) ASSET CONDITION MONITORING METHOD WITH AUTOMATIC ANOMALY DETECTION

(71) Applicant: ABB Schweiz AG, Baden (CH)

(72) Inventors: Benjamin Kloepper, Mannheim (DE); Jan-Christoph Schlake, Darmstadt (DE); Benedikt Schmidt, Heidelberg (DE); Bernhard Wullt, Vaesteras (SE); Anton Ronquist, Oerebro (SE)

(21) Appl. No.: 17/489,882

(22) Filed: Sep. 30, 2021

Related U.S. Application Data
(63) Continuation of application No. PCT/EP2019/058178, filed on Apr. 1, 2019.

(51) Int. Cl. G05B 23/02

(52) U.S. Cl. CPC G05B 23/0243

(57) ABSTRACT

An asset condition monitoring method with automatic anomaly detection may include receiving local condition data from an asset fleet, identifying at least one anomaly in the received condition data, identifying a new potential failure case dependent on the identified anomaly, determining a specific condition model dependent on the identified new potential failure case, where the specific condition model is configured for predicting the new potential failure case, and providing the specific condition model to the plurality of assets and/or to digital models of the plurality of assets.

### CROSS-REFERENCE TO PRIOR APPLICATION

This application is a continuation of International Patent Application No. PCT/EP2019/058178, filed on Apr. 1, 2019, the entire disclosure of which is hereby incorporated by reference herein.

### FIELD

One or more embodiments of the invention relates to an asset condition monitoring method as well as a device configured to execute such a method.

### BACKGROUND

Often, condition monitoring systems are set up during the commissioning phase of an asset and are seldom updated during the operation of the asset.

Traditionally, condition monitoring systems are tightly coupled to an asset, for example an industrial robot. Often, the condition monitoring logic is implemented on the local controller. Then, the condition of the asset is presented locally to the user in form of a traffic light system or a KPI. Sometimes, these KPIs are transferred to a central local, e.g. for report generation or to be used by service engineers.

Condition monitoring systems are often static and do not adapt themselves to given conditions over time like use, environment, system and/or application.

### SUMMARY

In an embodiment, the present invention provides an asset condition monitoring method with automatic anomaly detection. The method may include receiving local condition data from an asset fleet, identifying at least one anomaly in the received condition data, identifying a new potential failure case dependent on the at least one identified anomaly, determining a specific condition model dependent on the new potential failure case, wherein the specific condition model is configured for predicting the new potential failure case, and providing the specific condition model to a plurality of assets and/or to digital models of the plurality of assets.

An objective of the invention may be to provide an improved asset condition monitoring method. This objective may be achieved by a method of the present disclosure.

### BRIEF DESCRIPTION OF THE DRAWINGS

One or more embodiments of the present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 shows a schematic view of a condition monitoring arrangement with a device for asset condition monitoring with automatic anomaly detection;

FIG. 2 shows a schematic view of an asset condition monitoring method with automatic anomaly detection; and

FIG. 3 shows a detailed schematic view of an analytic unit.

### DETAILED DESCRIPTION

Further preferred embodiments are evident from the dependent patent claims.

According to one or more embodiments of the present invention an asset condition monitoring method with automatic anomaly detection may be provided, comprising the steps:

receiving local condition data from an asset fleet and;

identifying at least one anomaly in the received local condition data;

identifying a new potential failure case dependent on the determined anomaly;

determining a specific condition model dependent on the identified potential failure case, wherein the specific condition model is configured for predicting the new potential failure case; and

providing the specific condition model to the plurality of assets and/or to digital models of the plurality of assets.

Preferably, the asset fleet relates to a plurality of assets. The asset fleet is preferably determined by a type of asset, a customer, an application of the asset fleet, a configuration of the asset fleet, an operation cycle of the asset fleet, a software version of the asset fleet and/or a location of the different assets. A digital model of an asset relates to a digital twin of the asset. Thereby, one asset can relate to a plurality of asset fleets.

The term “asset”, as used herein, comprises any asset, which is suitable to form a fleet, preferably robots, in particular industrial robots, motors, generators and/or pumps.

The term “local condition data”, as used herein, relates to a condition and/or health state of an asset and/or an asset fleet. Additionally, the local condition data preferably comprises time series data of the condition and/or health state of an asset and/or an asset fleet.

The term “specific condition model”, as used herein, is also referred to as predictor since the specific condition model is configured for predicting a new, to this moment unknown, potential failure case. For example, given that the asset is an industrial robot, a new potential failure relates to a new failure in axis 3. The specific condition model is then configured to predict such new failure in axis 3 for condition monitoring of the asset.

Preferably, the received local condition data is stored on a cloud service. If the asset fleet is restricted to one location, a cloud service is not necessary, nevertheless may relieve the computational burden from a local infrastructure. However, if the assets are located at different locations, in particular at different plants, the use of the cloud service is preferred. While the local execution in a controller of an asset is limited by the computational power of the controller, in principal a huge number of different algorithms can be used in parallel for the same asset in the cloud. Alternatively, a local setup can be used similar to the cloud service avoiding computational burden on the controller. The local setup preferably comprises a dedicated controller for the asset fleet like an industrial PC. In addition, the local setup and the cloud service can be combined for a hybrid approach.

Preferably, the specific condition model is determined dependent on criteria, like asset type, application and/or customer.

Preferably, the anomaly is identified an anomaly detection method, which is configured for processing timeseries data and/or event data, further preferably an autoencoder, in particular a stacked autoencoder. Preferably, identifying the anomaly comprises annotating anomalies with failure cases. Thus, the determination of the specific condition model is simplified and/or structured.

Preferably, the specific condition model comprises a plurality of specific condition models each relating to a specific failure case. However, a single specific condition model relating to different specific failure cases is also possible.

Preferably, the specific condition model is used in a monitoring manner with the assets, in particular for monitoring alarms and/or key performance indicators, preferably by technical experts. Furthermore, with the digital models of the assets, the same specific condition model is used for predictive maintenance, for example sending a technical expert if a failure is predicted, and/or for root cause analysis.

Preferably, the identification of anomalies in the received local condition data is done fully automatically.

By iteratively identifying new potential failure cases and determining a specific condition model for predicting the new potential failure case, the asset condition monitoring method is improved. In other words, the asset condition monitoring method evolves from a standardized method, which only knows generic potential failure cases to a highly specified method, which can identify asset specific potential failure cases. Thus, the asset condition monitoring method can not only detect if there is a failure, but also, which specific failure case is present.

Using local condition data from an asset fleet compared to just a single asset, thereby considering a whole asset system, in particular a whole production line, improves the extensibility and/or updatability of the asset condition monitoring method.

Preferably, receiving the local condition data comprises automatically collecting data, in particular through physical signals, and/or collecting asset feedback from a user.

Thus, an improved asset condition monitoring method is provided.

In a preferred embodiment, the identified anomaly relates to unexpected condition data of the asset.

In other words, if the existing specific condition models are not able to predict a current condition and/or health state of the asset correctly, an anomaly in the received local condition data is detected. Therefore, preferably, a test is run on each of the available specific condition models and the result of the tests are compared with the provided local condition data. Thus, machine learning methods, in particular anomaly detection methods, and/or, artificial intelligence methods dependent on local condition data of an asset fleet can be employed.

The results of the tests are preferably triggered by time-calculation, in particular every hour, triggered every time a specific condition monitoring cycle was executed, calculated as a stream, in particular using a stream analytics calculation engine, and/or calculated as a batch, in particular for on demand analysis.

Preferably, identifying at least one anomaly comprises running a generic test. The generic test identifies the anomaly and/or prepares the anomaly for determining the new specific failure case.

Thus, an improved asset condition monitoring method is provided.

In a preferred embodiment, identifying anomalies in the received condition data comprises classifying identified failure cases and/or isolating faults in the identified anomaly.

Thus, an improved asset condition monitoring method is provided.

In a preferred embodiment, the local condition data comprise asset part specific data, preferably an acceleration of an asset part, a speed of an asset part, a position of an asset part, a torque of an asset part, vibration of an asset part, a current of an asset part, a voltage of an asset part, a live estimation of friction used in a drive line and/or drive system of an asset part, and/or a flow of dispensed materials fluids and/or gases of an asset part, in particular glue, wire, paint and/or inert gas.

For example, the asset is an industrial robot for a production line and an asset part is the gearbox of an axis of the robot.

Thus, an improved asset condition monitoring method is provided.

In a preferred embodiment, the method comprises the step of validating the specific condition model dependent on a machine learning algorithm, thereby determining validation data.

Preferably, the specific condition model is trained, developed, tested and/or validated by the machine learning algorithm using the condition data, in particular historical condition data.

Preferably, the machine learning algorithm comprises (logistic) regression, a support vector machine and/or a neuronal network, in particular a deep neuronal network.

Preferably, the machine learning algorithm comprises transfer learning approaches to simplify training models on fleet configurations and to allow model transformation over time.

Thus, an improved asset condition monitoring method is provided.

In a preferred embodiment, the method comprises the steps of adjusting the specific condition model dependent on the validation data, at least until a predetermined performance is met and providing the specific condition model to the plurality of assets and/or to the digital models of the plurality of assets, if the specific condition model meets the predetermined performance.

The term “performance”, as used herein, comprises a reliability and/or an accuracy of the specific condition model.

Preferably, edge analysis is used for adjusting the specific condition model, thereby discarding unnecessary data.

Thus, an improved asset condition monitoring method is provided.

In a preferred embodiment, the method comprises the steps of receiving additional system data from the plurality of assets, wherein the additional system data potentially have impact on the condition of the respective asset and identifying the new potential failure case dependent on the determined anomaly and the received system data.

Thus, an improved asset condition monitoring method is provided.

In a preferred embodiment the system data comprises environmental data, preferably from a motor of the asset, a simulation tool, a model of the asset, sensor data, preferably sound data and/or temperature data, an asset setup and/or an additional system, preferably production planning systems.

Thus, an improved asset condition monitoring method is provided.

In a preferred embodiment, the method comprises the step of combining specific condition models relating to different potential failure cases for failure case isolation.

For example, a specific condition model relating to a first axis can be combined with a specific condition model relating to a second axis, which is similar to the first axis. Thus, potential failure cases of one part of an asset can be transferred to a second part of an asset.

Thus, an improved asset condition monitoring method is provided.

In a preferred embodiment, the specific condition model replaces an existing specific condition model.

Preferably, improved specific condition models replace existing specific condition models in order to iteratively improve the specific condition models. However, a newly determined and/or provided specific condition model can also just be added to the existing specific condition models to increase the variety of specific condition models.

Thus, an improved asset condition monitoring method is provided.

In a preferred embodiment, the method comprises the step of indicating the new potential failure case of the asset and/or predicting the new potential failure case of the asset dependent on the provided specific condition model.

Preferably, the indication and/or prediction is visualised by key performance indicators, a heatmap and/or a traffic light system.

Thus, an improved asset condition monitoring method is provided.

According to an aspect, a device is provided, configured for executing a method, as described herein.

According to an aspect, a computer program is provided, comprising instructions which, when the program is executed by a computer, cause the computer to carry out the method, as described herein.

According to an aspect, a computer-readable data carrier is provided, having stored there on the computer program, as described herein.

One or more embodiments of the present invention may also relate to a computer program product including computer program code for controlling one or more processors of a device adapted to be connected to a communication network and/or configured to store a standardized configuration representation, particularly, a computer program product including a computer readable medium containing therein the computer program code.

Preferably, the functional modules and/or the configuration mechanisms are implemented as programmed software modules or procedures, respectively; however, one skilled in the art will understand that the functional modules and/or the configuration mechanisms can be implemented fully or partially in hardware.

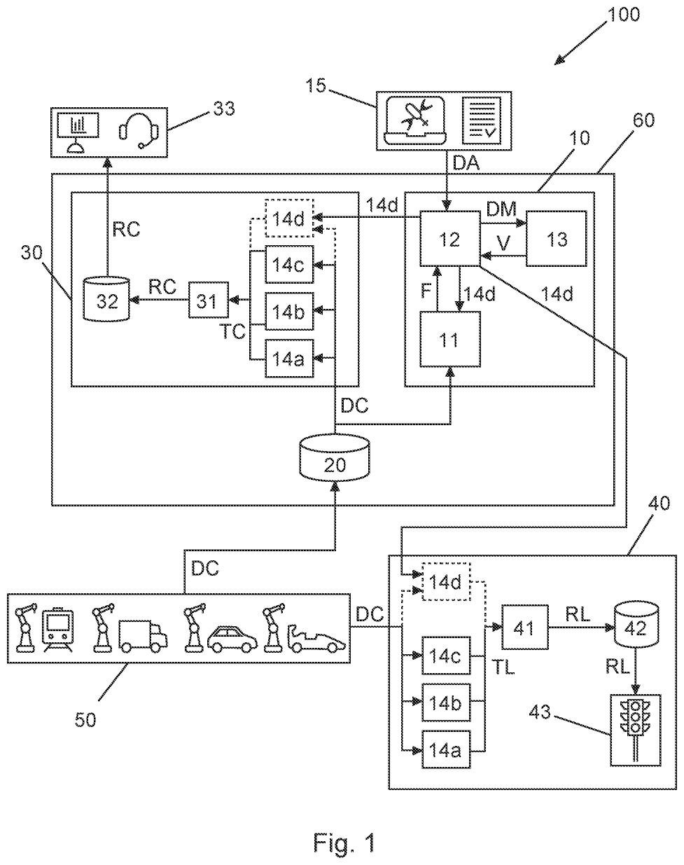

FIG. 1 shows a schematic view of a condition monitoring arrangement 100 comprising a device 10, a database 20, cloud testing unit 30, a local testing unit 40, an asset fleet 50 and a cloud 60. The device 10, the database and the cloud testing unit 30 all run in the cloud 60.

The asset fleet 50, in this example, comprises a plurality of assets, in this case robots for producing different vehicles like trains, trucks, cars and/or sport cars. The condition of the assets is monitored and thereby local condition data DC is determined, relating to the condition of each of the robots. The condition data DC is collected in the database 20. From there, the condition data 20 is provided to the device 10. The device 10 comprises an analytic unit 11, a model unit 12 and a machine learning unit 13. The analytic unit 11 receives the condition data 20. Dependent on the condition data 20, the analytic unit identifies an anomaly A in the condition data 20 and dependent on the anomaly A identifies a new potential failure case F. The anomaly A in this case relates to an unknown failure of a robot in the condition data 20. By analysing the anomaly A, in particular in view of additional system data (not shown) provided by the respective robot, in this case the setup of the robot, the failure case F can be identified. For example, the failure case F describes a failure in the gearbox of axis 3 of the robot.

The new potential failure case F is then provided to the model unit 12, which is configured for determining a new specific condition model 14d dependent on the identified new potential failure case F, wherein the new specific condition model 14d is configured for predicting the new potential failure case F. However, the new specific condition model 14d does not yet meet predetermined performance criteria, in other word, the specific condition model 14d does not predict a condition problem and/or a failure of the robot in a reliable or accurate way. Therefore, model data DM relating to the new specific condition model 14d is provided to the machine learning unit 13. Based on machine learning algorithms, the machine learning unit 13 validates the model data DM and therefore the specific condition model 14d, thereby determining validation data V. Based on the validation data V, the model unit 12 adjusts the new specific condition model 14d. This iteration between the model unit 12 and the machine learning unit 13 is repeated until the specific condition model 14 does meet the predetermined performance criteria. The iteration process in this example is supervised by analysts 15, which provide analyst data DA, to improve the iteration process between the model unit 12 and the machine learning unit 13.

The specific condition model 14 is then provided back to the analytic unit 11. The analytic unit 11 is thereby improved by a new way to identify a specific failure of one of the assets based on the condition data DC.

Additionally, the new specific condition model 14d is provided to the cloud testing unit 30. The cloud testing unit 30 comprises already known specific condition models 14b and 14c as well as a generic condition model 14a. The generic condition model 14a can only make a statement about a robot if a failure is predicted or not, but cannot specify the failure. The known specific models 14b and 14c can detect specific failures, in this case a failure relating to a screw and a failure relating to a motor of the robot. Based on the condition data DC each test can provide cloud test results TC, which are processed by a cloud fault isolation unit 31. The cloud fault isolation unit 31 provides cloud results RC to a cloud result database 32. From there, the cloud results RC can be provided to consumers 33, in this case clients, which want to know a prediction of condition failures of the processed asset fleet 50. Since the device 10 has provided the new specific condition model 14d, it is also possible to predict failures specifically in axis 3 of the robot.

The same applies to the local testing unit 40. The new specific condition model 14d is provided to the local testing unit 14. In this application, the condition models 14a, 14b, 14c and 14d do not try to predict a future failure of a robot, but indicate already existing failures of specific robots. Therefore, the condition models 14a, 14b, 14c and 14d provide local test results TL, which are provided to a local fault isolation unit 41. The local fault isolation unit 41 provides local results RL to a local result database 43. From there, the local test results TL are provided to a condition display device 43, in this case in form of a traffic light, indicating the failure of a robot. Based on the new condition model 14d, a failure specifically in axis 3 of the specific robot can be detected and indicated.

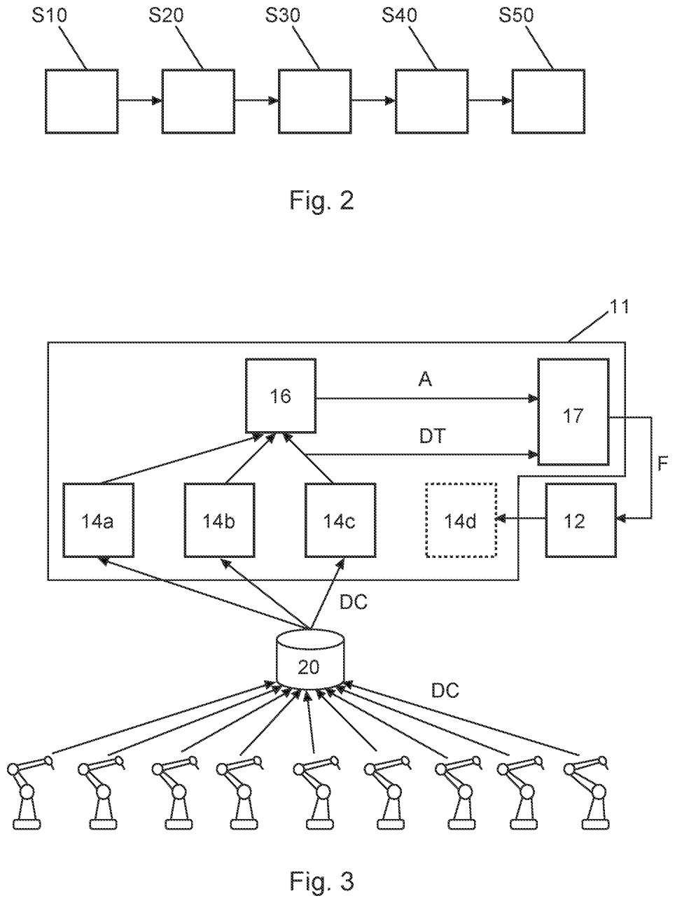

FIG. 2 shows a schematic view of an asset condition monitoring method with automatic anomaly detection. In step S10 local condition data DC are received from a fleet 50 of assets. In step S20 anomalies A are identified in the received condition data DC. In step S30, a new potential failure case F is identified dependent on the identified anomaly A. In step S40, a specific condition model 14d is determined dependent on the identified new potential failure case F, wherein the specific condition model 14d is configured for predicting the new potential failure case F. In step S50, the specific condition model 14d is provided to the plurality of assets and/or to digital models of the plurality of assets.

FIG. 3 shows a detailed schematic view of the analytic unit 11. The analytic unit 11 comprises an anomaly identification unit 16 and a failure case identification unit 17. In this example, the analytic unit 11 already knows the generic condition model 14a and the specific condition models 14b and 14c, as described in the cloud testing unit 30 of FIG. 1. Based on the condition models 14a, 14b, 14c, test data DT is provided to the identification unit 16. If the generic condition model 14a provides test data DT, which indicate a failure, but the specific condition models 14b, 14c do not indicate a failure, an anomaly A is determined. In this case, there is a failure in axis 3 of the robot, which cannot be identified by the generic condition model 14a and the specific condition model 14b, 14c. Based on the anomaly A and the test data DT, the failure case identification unit 17 identifies a new failure case F. Based on the failure case F, the model unit 12 determines a new specific condition model 14d, which is then provided back to the analytic unit 11. The analytic process of the model unit 12 is supervised by the analyst 15. The analyst 15 is involved in the analytic process and provides analyst data DA to the model unit 12. The model unit 12 thus determines the new specific condition model 14d based on the failure case F and the analyst data DA. Thus, in the future, a failure in axis 3 of the robot can be identified by the analytic unit 11 based on the new specific condition model 14d. Thus, the device for condition monitoring can be iteratively improved.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SYMBOLS

10 device
11 analytic unit
12 model unit
13 machine learning unit
14a generic condition model
14b specific condition model
14c specific condition model
14d new specific condition model
15 analyst
16 anomaly identification unit
17 failure case identification unit
20 database
30 cloud testing unit
31 cloud fault isolation unit
32 cloud result database
33 consumer
40 local testing unit
41 local fault isolation unit
42 local result database
43 condition display device
50 asset fleet
60 cloud
100 condition monitoring arrangement
DC condition data
V validation data
DM model data
DA analyst data
A anomaly
F failure case
TC cloud test result
RL cloud result
TL local test result
RL local result
TD test data

What is claimed is:

1. An asset condition monitoring method with automatic anomaly detection, comprising:
receiving local condition data from an asset fleet;
identifying at least one anomaly in the received condition data;
identifying a new potential failure case dependent on the at least one identified anomaly;
determining a specific condition model dependent on the new potential failure case, wherein the specific condition model is configured for predicting the new potential failure case; and
providing the specific condition model to a plurality of assets and/or to digital models of the plurality of assets.

2. The method of claim 1, wherein
the at least one identified anomaly relates to unexpected condition data of a first asset of the plurality of assets.

3. The method of claim 1, wherein
identifying the at least one anomaly in the received condition data comprises classifying identified failure cases and/or isolating faults in the at least one identified anomaly.

4. The method of claim 1, wherein
the received condition data comprise asset part specific data.

5. The method of claim 1, further comprising:
validating the specific condition model dependent on a machine learning algorithm, thereby determining validation data.

6. The method of claim 1, further comprising:
adjusting the specific condition model dependent on the validation data, at least until a predetermined performance is met; and
providing the specific condition model to the plurality of assets and/or to the digital models of the plurality of assets, if the specific condition model meets the predetermined performance.

7. The method of claim 1, further comprising:
receiving additional system data from the plurality of assets, wherein the additional system data potentially have impact on the condition of the first asset; and
identifying the new potential failure case dependent on the determined anomaly and the received system data.

8. The method of claim 6, wherein
the system data comprises environmental data.

9. The method of claim 1, further comprising:
combining specific condition models relating to different potential failure cases for failure case isolation.

10. The method of claim 1, wherein
the determined specific condition model replaces existing specific condition models.

11. The method of claim 1, further comprising:
indicating the new potential failure case of the first asset and/or predicting the new potential failure case of the first asset dependent on the provided specific condition model.

12. A device, configured for executing a method of claim 1.

13. A computer program, comprising instructions which, when the program is executed by a computer, cause the computer to carry out the method of claim 1.

14. A computer-readable data carrier, having stored thereon the computer program of claim 13.

15. The method of claim 4, wherein
the asset part specific data comprise at least one member of a group consisting of an acceleration of an asset part, a speed of an asset part, a position of an asset part, a torque of an asset part, vibration of an asset part, a current of an asset part, a voltage of an asset part, a live estimation of friction used in a drive line of an asset part, a live estimation of friction used in a drive system of an asset part, and a flow of dispensed materials, fluids, and/or gases of an asset part.

16. The method of claim 15, wherein:
the asset part specific data comprise an acceleration of an asset part, a speed of an asset part, a position of an asset part, a torque of an asset part, vibration of an asset part, a current of an asset part, a voltage of an asset part, a flow of dispensed materials, fluids, and/or gases, and at least one member of a group consisting of a live estimation of friction used in a drive line of an asset part and a live estimation of friction used in a drive system of an asset part, and
the dispensed material, fluids, and gases comprise at least one member of a group consisting of glue, wire, paint and inert gas.

17. The method of claim 8, wherein
the environmental data comprises at least one member of a group consisting of a motor of the first asset, a simulation tool, a model of the first asset, sensor data, an asset setup, and an additional system.

18. The method of claim 17, wherein
the sensor data comprises at least one member of a group consisting of sound data and temperature data, and
the additional system comprises at least one production planning system.
